(19) United States
(12) Patent Application Publication
(10) Pub. No.: US 2025/0031006 A1
(43) Pub. Date: Jan. 23, 2025

(54) ACOUSTIC PROCESSING METHOD, RECORDING MEDIUM, AND ACOUSTIC PROCESSING SYSTEM

(71) Applicant: Panasonic Intellectual Property Corporation of America, Torrance, CA (US)

(72) Inventors: Kota NAKAHASHI, Osaka (JP); Seigo ENOMOTO, Kyoto (JP); Hikaru USAMI, Osaka (JP); Mariko YAMADA, Hyogo (JP); Hiroyuki EHARA, Kanagawa (JP); Ko MIZUNO, Osaka (JP); Tomokazu ISHIKAWA, Osaka (JP)

(21) Appl. No.: 18/906,872

(22) Filed: Oct. 4, 2024

Related U.S. Application Data
(63) Continuation of application No. PCT/JP2023/014059, filed on Apr. 5, 2023.
(60) Provisional application No. 63/330,924, filed on Apr. 14, 2022.

(30) Foreign Application Priority Data
Jan. 26, 2023 (JP) 2023-010116

(51) Int. Cl. H04S 7/00

(52) U.S. Cl. CPC H04S 7/304; H04S 7/305; H04S 2400/11

(57) ABSTRACT

In an acoustic processing method, (i) sound information related to a sound including a predetermined sound and (ii) metadata including information related to a space in which the predetermined sound is reproduced are obtained; based on the sound information and the metadata, sound image localization enhancement processing of generating a first sound signal expressing a sound including a sound image localization enhancement reflected sound for localization as a sound arriving from a predetermined direction is performed; based on the sound information and the metadata, acoustic processing of generating a second sound signal expressing a sound including a sound other than a direct sound that reaches a user directly from a sound source object is performed; and an output sound signal obtained by compositing the first sound signal and the second sound signal is output.

### CROSS REFERENCE TO RELATED APPLICATIONS

This is a continuation application of PCT International Application No. PCT/JP2023/014059 filed on Apr. 5, 2023, designating the United States of America, which is based on and claims priority of U.S. Provisional Patent Application No. 63/330,924 filed on Apr. 14, 2022, and Japanese Patent Application No. 2023-010116 filed on Jan. 26, 2023. The entire disclosures of the above-identified applications, including the specifications, drawings and claims are incorporated herein by reference in their entirety.

### FIELD

The present disclosure relates to an acoustic processing method, a recording medium, and an acoustic processing system for realizing stereoscopic acoustics in a space.

### BACKGROUND

PTL 1 discloses a headphone playback device that localizes a sound image outside of a listener's head.

### CITATION LIST

### Patent Literature

PTL 1: Japanese Patent No. 2900985

### SUMMARY

### Technical Problem

An object of the present disclosure is to provide an acoustic processing method and the like that make it easy for a user to perceive a stereoscopic sound more appropriately.

### Solution to Problem

In an acoustic processing method according to one aspect of the present disclosure, (i) sound information related to a sound including a predetermined sound and (ii) metadata including information related to a space in which the predetermined sound is reproduced are obtained. In the acoustic processing method, based on the sound information and the metadata, sound image localization enhancement processing of generating a first sound signal expressing a sound including a sound image localization enhancement reflected sound for localization as a sound arriving from a predetermined direction is performed. In the acoustic processing method, based on the sound information and the metadata, acoustic processing of generating a second sound signal expressing a sound including a sound other than a direct sound that reaches a user directly from a sound source object is performed. In the acoustic processing method, an output sound signal obtained by compositing the first sound signal and the second sound signal is output. At least one of the sound image localization enhancement processing or the acoustic processing is performed with reference to a parameter used in an other of the sound image localization enhancement processing or the acoustic processing.

A recording medium according to one aspect of the present disclosure is a non-transitory computer-readable recording medium having recorded thereon a program for causing a computer to execute the acoustic processing method.

An acoustic processing system according to one aspect of the present disclosure includes an obtainer, a sound image localization enhancement processor, an acoustic processor, and an outputter. The obtainer obtains (i) sound information related to a sound including a predetermined sound and (ii) metadata including information related to a space in which the predetermined sound is reproduced. The sound image localization enhancement processor performs, based on the sound information and the metadata, sound image localization enhancement processing of generating a first sound signal expressing a sound including a sound image localization enhancement reflected sound for localization as a sound arriving from a predetermined direction. The acoustic processor performs, based on the sound information and the metadata, acoustic processing of generating a second sound signal expressing a sound including a sound other than a direct sound that reaches a user directly from a sound source object. The outputter outputs an output sound signal obtained by compositing the first sound signal and the second sound signa. At least one of the sound image localization enhancement processing or the acoustic processing is performed with reference to a parameter used in an other of the sound image localization enhancement processing or the acoustic processing.

Note that these comprehensive or specific aspects may be realized by a system, a device, a method, an integrated circuit, a computer program, or a non-transitory computer-readable recording medium such as a CD-ROM, or may be implemented by any desired combination of systems, devices, methods, integrated circuits, computer programs, and recording media.

### Advantageous Effects

The present disclosure has an advantage in that it is easy for a user to perceive a stereoscopic sound more appropriately.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating a use case for an acoustic reproduction device according to an embodiment.

FIG. 2 is a block diagram illustrating the functional configuration of the acoustic reproduction device according to the embodiment.

FIG. 3 is a block diagram illustrating the functional configuration of the acoustic processing system according to the embodiment in more detail.

FIG. 4 is an explanatory diagram illustrating an example of basic operations performed in the acoustic processing system according to the embodiment.

FIG. 5 is a flowchart illustrating an example of reciprocal processing performed between sound image localization enhancement processing and initial reflected sound generation processing according to the embodiment.

FIG. 6 is an explanatory diagram illustrating a relationship between sound image localization enhancement reflected sound and initial reflected sound according to an embodiment.

FIG. 7 is a flowchart illustrating an example of reciprocal processing performed between sound image localization enhancement processing and later reverberation sound generation processing according to the embodiment.

FIG. 8 is an explanatory diagram illustrating a relationship between a sound image localization enhancement reflected sound and a later reverberation sound according to an embodiment.

FIG. 9 is a flowchart illustrating an example of reciprocal processing performed between sound image localization enhancement processing and diffracted sound generation processing according to the embodiment.

FIG. 10 is an explanatory diagram illustrating a relationship between sound image localization enhancement reflected sound and diffracted sound according to an embodiment.

FIG. 11 is an explanatory diagram illustrating operations performed by a sound image localization enhancement processor according to a variation on the embodiment.

### DESCRIPTION OF EMBODIMENTS

### Underlying Knowledge Forming Basis of Present Disclosure

Techniques related to acoustic reproduction have been known which cause a user to perceive stereoscopic sound by controlling the position at which the user senses a sound image, which is a sound source object, in a virtual three-dimensional space (sometimes called a “three-dimensional sound field” hereinafter). By localizing the sound image at a predetermined position in the virtual three-dimensional space, the user can perceive this sound as if it were arriving from a direction parallel to the straight line connecting the predetermined position and the user (i.e., a predetermined direction). To localize a sound image at a predetermined position in a virtual three-dimensional space in such a manner, it is necessary, for example, to perform calculation processing on collected sound which produces a difference in times at which the sound arrives between the two ears, a difference in the levels (or sound pressures) of the sounds between the two ears, and the like such that the sound is perceived as being a stereoscopic sound.

Technologies related to virtual reality (VR) or augmented reality (AR) are being developed extensively in recent years. For example, in virtual reality, the position of a virtual space does not follow the movement of the user, with the focus being placed on enabling the user to feel as if they were actually moving within the virtual space. In virtual reality or augmented reality technology, particular attempts are being made to further enhance the sense of realism by combining auditory elements with the visual elements. Enhancing the localization of the sound image as described above is particularly useful to make sounds seem as if they are being heard from outside the user's head, to improve the sense of auditory immersion.

Incidentally, in addition to the above-described processing for enhancing the localization of a sound image (also called “sound image localization enhancement processing” hereinafter), various other types of acoustic processing are useful for realizing stereoscopic acoustics in a three-dimensional sound field. Here, “acoustic processing” refers to processing that generates sound, other than direct sound moving from a sound source object to a user, in the three-dimensional sound field.

Acoustic processing can include processing that generates an initial reflected sound (also called “initial reflected sound generation processing” hereinafter), for example. An “initial reflected sound” is a reflected sound that reaches the user after at least one reflection at a relatively early stage after the direct sound from the sound source object reaches the user (e.g., several tens of ms after the time at which the direct sound arrives).

Acoustic processing can also include processing that generates a later reverberation sound (also called “later reverberation sound generation processing” hereinafter), for example. The “later reverberation sound” is a reverberation sound that reaches the user at a relatively late stage after the initial reflected sound reaches the user (e.g., between about 100 and 200 ms after the time at which the direct sound arrives), and reaches the user after more reflections (e.g., several tens) than the number of reflections of the initial reflected sound.

Acoustic processing can also include processing that generates a diffracted sound (also called “diffracted sound generation processing” hereinafter), for example. The “diffracted sound” is a sound that, when there is an obstacle between the sound source object and the user, reaches the user from the sound source object having traveled around the obstacle.

When sound image localization enhancement processing is performed independent from such acoustic processing, there is a problem in that (i), the reflected sound generated to enhance the localization of the sound image and the sound generated by the acoustic processing may interfere with each other and strengthen or weaken each other, resulting in an insufficient sound image localization enhancement effect, and (ii), it is difficult to achieve the desired stereoscopic acoustics.

In view of the foregoing, an object of the present disclosure is to provide an acoustic processing method and the like that make it easy for a user to perceive stereoscopic sound more appropriately by referring to parameters used in at least one of sound image localization enhancement processing and acoustic processing when performing the other.

More specifically, an acoustic processing method according to a first aspect of the present disclosure includes: obtaining (i) sound information related to a sound including a predetermined sound and (ii) metadata including information related to a space in which the predetermined sound is reproduced; performing, based on the sound information and the metadata, sound image localization enhancement processing of generating a first sound signal expressing a sound including a sound image localization enhancement reflected sound for localization as a sound arriving from a predetermined direction; performing, based on the sound information and the metadata, acoustic processing of generating a second sound signal expressing a sound including a sound other than a direct sound that reaches a user directly from a sound source object; and outputting an output sound signal obtained by compositing the first sound signal and the second sound signal. At least one of the sound image localization enhancement processing or the acoustic processing is performed with reference to a parameter used in an other of the sound image localization enhancement processing or the acoustic processing.

Through this, the sound generated by at least one of the sound image localization enhancement processing and the acoustic processing is adjusted in accordance with the sound generated by the other instance of the processing, which provides an advantage in that it is easier for a user to perceive a stereoscopic sound more appropriately than if the sound image localization enhancement processing and the acoustic processing were performed independently.

Additionally, in an acoustic processing method according to a second aspect of the present disclosure, in, for example, the acoustic processing method according to the first aspect, the acoustic processing includes initial reflected sound generation processing of generating the second sound signal expressing a sound including an initial reflected sound that reaches the user after the direct sound. In the performing of the acoustic processing, a parameter of at least one of the sound image localization enhancement reflected sound or the initial reflected sound is adjusted based on a timing at which the sound image localization enhancement reflected sound is generated and a timing at which the initial reflected sound is generated.

Through this, it is unlikely that the sound image localization enhancement reflected sound and initial reflected sound will interfere with each other, which provides an advantage in that it is easy for a user to properly perceive a stereoscopic sound including the sound image localization enhancement reflected sound and the initial reflected sound.

Additionally, in an acoustic processing method according to a third aspect of the present disclosure, in, for example, the acoustic processing method according to the first or second aspect, the acoustic processing includes later reverberation sound generation processing of generating the second sound signal expressing a sound including a later reverberation sound that reaches the user after the direct sound as a reverberation. In the performing of the acoustic processing, a parameter of at least one of the sound image localization enhancement reflected sound or the later reverberation sound is adjusted based on a sound pressure of the later reverberation sound.

Through this, it is easy for the sound image localization enhancement reflected sound to be enhanced with respect to the later reverberation sound, which provides an advantage in that it is easy for a user to properly perceive a stereoscopic sound including the sound image localization enhancement reflected sound and the later reverberation sound.

Additionally, in an acoustic processing method according to a fourth aspect of the present disclosure, in, for example, the acoustic processing method according to any one of the first to third aspects, the acoustic processing includes diffracted sound generation processing of generating the second sound signal expressing a sound including a diffracted sound caused by an obstacle located between the user and the sound source object in the space. In the performing of the acoustic processing, a parameter of at least one of the sound image localization enhancement reflected sound or the diffracted sound is adjusted.

Through this, it is easy for the sound image localization enhancement reflected sound to be enhanced with respect to the diffracted sound, which provides an advantage in that it is easy for a user to properly perceive a stereoscopic sound including the sound image localization enhancement reflected sound and the diffracted sound.

Additionally, in an acoustic processing method according to a fifth aspect of the present disclosure, in, for example, the acoustic processing method according to any one of the first to fourth aspects, the metadata includes information indicating which of the sound image localization enhancement processing or the acoustic processing is to be prioritized.

Through this, which of the sound image localization enhancement reflected sound or the sound generated by the acoustic processing to prioritize is determined according to the space in which the predetermined sound is reproduced, which provides an advantage in that it is easy for the user to perceive a stereoscopic sound more appropriately.

Additionally, in an acoustic processing method according to a sixth aspect of the present disclosure, in, for example, the acoustic processing method according to any one of the first to fifth aspects, the sound image localization enhancement processing includes generating the first sound signal based on a position of the user and a position of the sound source object in the space.

Through this, an appropriate sound image localization enhancement reflected sound is generated in accordance with the positional relationship between the user and the sound source object, which provides an advantage in that it is easy for the user to perceive stereoscopic sound more appropriately.

Additionally, for example, a recording medium according to a seventh aspect of the present disclosure is a non-transitory computer-readable recording medium having recorded thereon a program for causing a computer to execute the acoustic processing method according to any one of the first to sixth aspects.

This has an advantage that the same effects as those of the above-described acoustic processing method can be achieved.

Additionally, for example, an acoustic processing system according to an eighth aspect of the present disclosure includes an obtainer, a sound image localization enhancement processor, an acoustic processor, and an outputter. The obtainer obtains (i) sound information related to a sound including a predetermined sound and (ii) metadata including information related to a space in which the predetermined sound is reproduced. The sound image localization enhancement processor performs, based on the sound information and the metadata, sound image localization enhancement processing of generating a first sound signal expressing a sound including a sound image localization enhancement reflected sound for localization as a sound arriving from a predetermined direction. The acoustic processor performs, based on the sound information and the metadata, acoustic processing of generating a second sound signal expressing a sound including a sound other than a direct sound that reaches a user directly from a sound source object. The outputter outputs an output sound signal obtained by compositing the first sound signal and the second sound signa. At least one of the sound image localization enhancement processing or the acoustic processing is performed with reference to a parameter used in an other of the sound image localization enhancement processing or the acoustic processing.

This has an advantage that the same effects as those of the above-described acoustic processing method can be achieved.

Furthermore, these comprehensive or specific aspects of the present disclosure may be realized by a system, a device, a method, an integrated circuit, a computer program, or a non-transitory computer-readable recording medium such as a CD-ROM, or may be implemented by any desired combination of systems, devices, methods, integrated circuits, computer programs, and recording media.

An embodiment will be described in detail hereinafter with reference to the drawings. The following embodiment will describe a general or specific example. The numerical values, shapes, materials, constituent elements, arrangements and connection states of constituent elements, steps, orders of steps, or the like in the following embodiments are merely examples, and are not intended to limit the present disclosure. Additionally, of the constituent elements in the following embodiment, constituent elements not denoted in the independent claims will be described as optional constituent elements. Note also that the drawings are schematic diagrams, and are not necessarily exact illustrations. Configurations that are substantially the same are given the same reference signs in the drawings, and redundant descriptions may be omitted or simplified.

### Embodiment

### 1. Overview

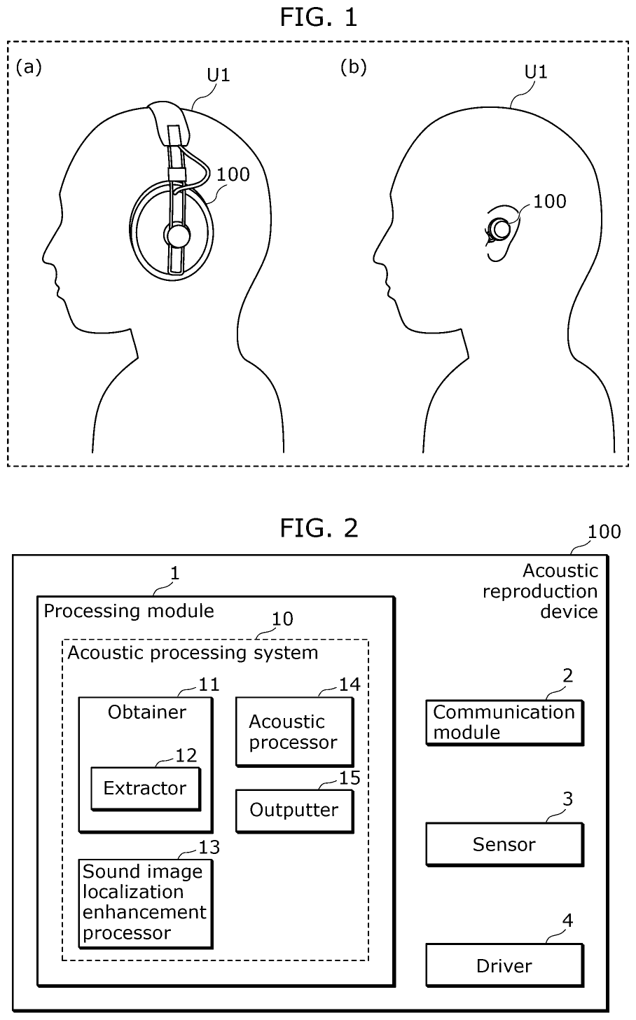

An overview of an acoustic reproduction device according to an embodiment will be described first. FIG. 1 is a schematic diagram illustrating a use case for the acoustic reproduction device according to the embodiment. (a) in FIG. 1 illustrates user U1 using one example of acoustic reproduction device 100. (b) in FIG. 1 illustrates user U1 using another example of acoustic reproduction device 100.

Acoustic reproduction device 100 illustrated in FIG. 1 is used in conjunction with, for example, a display device that displays images or a stereoscopic video reproduction device that reproduces stereoscopic video. A stereoscopic video reproduction device is an image display device worn on the head of user U1, and changing the images displayed in response to movement of the head of user U1 causes user U1 to feel as if they are moving their head in a three-dimensional sound field (a virtual space).

In addition, the stereoscopic video reproduction device displays two images with parallax deviation between the left and right eyes of user U1. User U1 can perceive the three-dimensional position of an object in the image based on the parallax deviation between the displayed images. Although a stereoscopic video reproduction device is described here, the device may be a normal image display device, as described above.

Acoustic reproduction device 100 is a sound presentation device worn on the head of user U1. Acoustic reproduction device 100 therefore moves with the head of user U1. For example, acoustic reproduction device 100 in the embodiment may be what is known as an over-ear headphone-type device, as illustrated in (a) of FIG. 1, or may be two earplug-type devices worn separately in the left and right ears of user U1, as illustrated in (b) of FIG. 1. By communicating with each other, the two devices present sound for the right ear and sound for the left ear in a synchronized manner. By changing the sound presented in accordance with movement of the head of user U1, acoustic reproduction device 100 causes user U1 to feel as if user U1 is moving their head in a three-dimensional sound field. Accordingly, as described above, acoustic reproduction device 100 moves the three-dimensional sound field relative to the movement of user U1 in a direction opposite from the movement of user U1.

### 2. Configuration

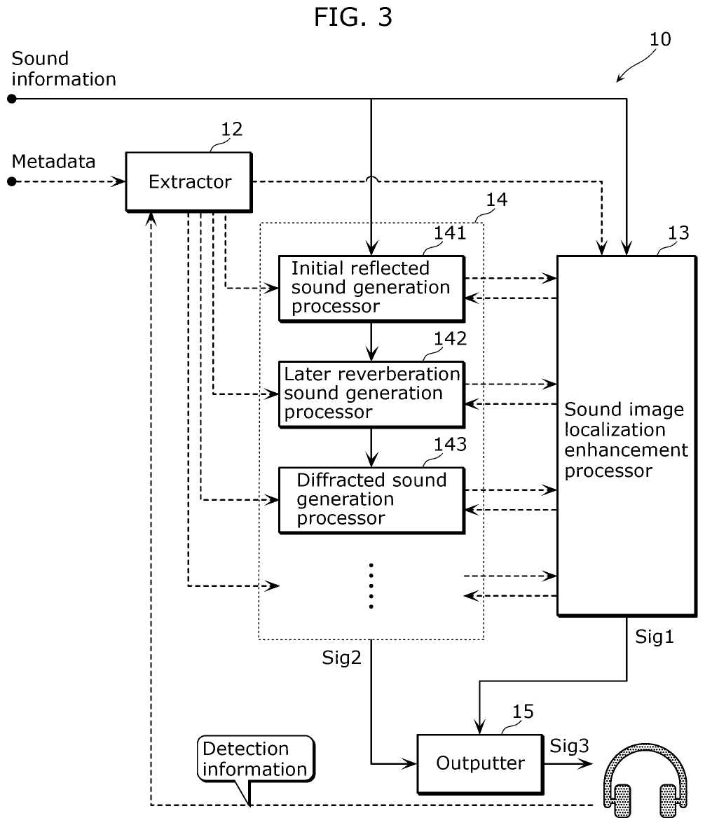

The configuration of acoustic reproduction device 100 according to the embodiment will be described next with reference to FIGS. 2 and 3. FIG. 2 is a block diagram illustrating the functional configuration of acoustic reproduction device 100 according to the embodiment. FIG. 3 is a block diagram illustrating the functional configuration of acoustic processing system 10 according to the embodiment in more detail. As illustrated in FIG. 2, acoustic reproduction device 100 according to the embodiment includes processing module 1, communication module 2, sensor 3, and driver 4.

Processing module 1 is a computing device for performing various types of signal processing in acoustic reproduction device 100. Processing module 1 includes a processor and a memory, for example, and implements various functions by using the processor to execute programs stored in the memory.

Processing module 1 functions as acoustic processing system 10 including obtainer 11, sound image localization enhancement processor 13, acoustic processor 14, and outputter 15, with obtainer 11 including extractor 12.

Each function unit of acoustic processing system 10 will be described below in detail in conjunction with details of configurations aside from processing module 1.

Communication module 2 is an interface device for accepting the input of sound information and the input of metadata to acoustic reproduction device 100. Communication module 2 includes, for example, an antenna and a signal converter, and receives the sound information and metadata from an external device through wireless communication. More specifically, communication module 2 uses the antenna to receive a wireless signal expressing sound information converted into a format for wireless communication, and reconverts the wireless signal into the sound information using the signal converter. Through this, acoustic reproduction device 100 obtains the sound information through wireless communication from an external device. Likewise, communication module 2 uses the antenna to receive a wireless signal expressing metadata converted into a format for wireless communication, and reconverts the wireless signal into the metadata using the signal converter. Through this, acoustic reproduction device 100 obtains the metadata through wireless communication from an external device. The sound information and metadata obtained by communication module 2 are both obtained by obtainer 11 of processing module 1. Note that communication between acoustic reproduction device 100 and the external device may be performed through wired communication.

In the present embodiment, acoustic reproduction device 100 includes acoustic processing system 10, which functions as a renderer that generates sound information to which an acoustic effect is added. However, a server may handle some or all of the functions of the renderer. In other words, some or all of obtainer 11, extractor 12, sound image localization enhancement processor 13, acoustic processor 14, and outputter 15 may be provided in a server (not shown). In this case, sound signals generated by sound image localization enhancement processor 13 and acoustic processor 14 in the server, or a sound signal obtained by compositing sound signals generated by individual processors, is received and reproduced by acoustic reproduction device 100 through communication module 2.

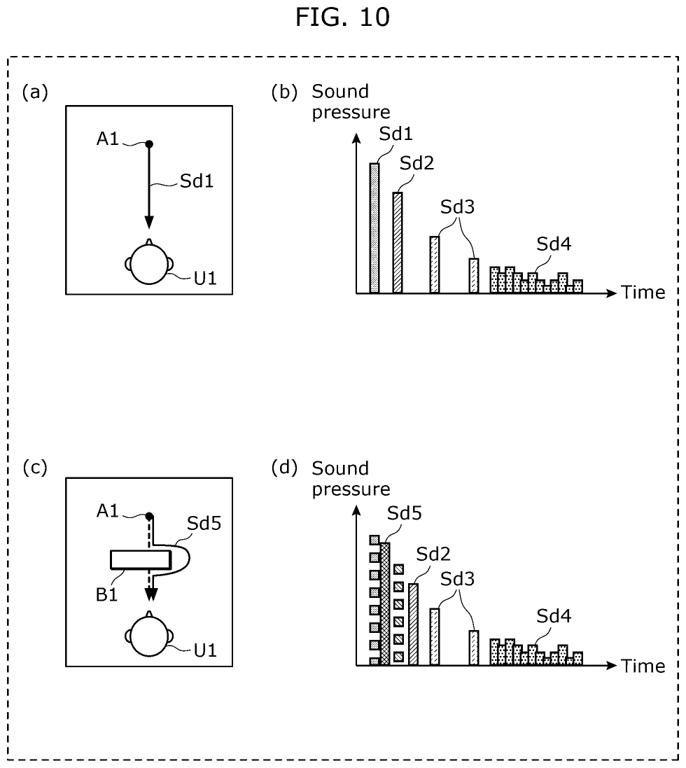

In the embodiment, the sound information and metadata are obtained by acoustic reproduction device 100 as bitstreams encoded in a predetermined format, such as MPEG-H 3D Audio (ISO/IEC 23008-3), for example. As an example, the encoded sound information includes information about a predetermined sound to be reproduced by acoustic reproduction device 100. Here, the predetermined sound is a sound emitted by sound source object A1 (see FIG. 10 and the like) present in the three-dimensional sound field or a natural environment sound, and may include, for example, the sound of a machine, the voice of a living thing including a person, and the like. Note that if a plurality of sound source objects A1 are present in the three-dimensional sound field, acoustic reproduction device 100 obtains a plurality of items of sound information corresponding to each of the plurality of sound source objects A1.

The metadata is information used in acoustic reproduction device 100 to control acoustic processing performed on the sound information, for example. The metadata may be information used to describe a scene represented in the virtual space (the three-dimensional sound field). Here, “scene” is a term referring to a collection of all elements expressing three-dimensional video and acoustic events in a virtual space, modeled by acoustic processing system 10 using the metadata. In other words, the “metadata” mentioned here may include not only information for controlling acoustic processing, but also information for controlling video processing. Of course, the metadata may include information for controlling only one of acoustic processing or video processing, or may include information used for both types of control.

Acoustic reproduction device 100 generates a virtual acoustic effect by performing acoustic processing on the sound information using the metadata included in the bitstream and additional obtained information, such as interactive position information of user U1 and the like. Although the present embodiment describes a case where the generation of an initial reflected sound, a diffracted sound, and a later reverberation sound, and sound image localization processing, are performed as acoustic effects, other acoustic processing may be performed using the metadata. For example, it is conceivable to add an acoustic effect such as a distance damping effect, localization, or a Doppler effect. Additionally, information that switches some or all acoustic effects on and off may be added as metadata.

Note that some or all of the metadata may be obtained from sources other than the bitstream of the sound information. For example, the metadata controlling acoustics or the metadata controlling video may be obtained from sources other than bitstreams, or both items of the metadata may be obtained from sources other than bitstreams.

In addition, if the metadata controlling the video is included in the bitstream obtained by acoustic reproduction device 100, acoustic reproduction device 100 may be provided with a function for outputting the metadata that can be used to control the video to a display device that displays images or a stereoscopic video reproduction device that reproduces the stereoscopic video. As an example, the encoded metadata includes (i) information about sound source object A1 that emits a sound and a three-dimensional sound field (space) including obstacle B1 (see FIG. 10), and (ii) information about a localization position when the sound image of the sound is localized at a predetermined position within the three-dimensional sound field (that is, is caused to be perceived as a sound arriving from a predetermined direction), i.e., information about the predetermined direction. Here, obstacle B1 is an object that can affect the sound perceived by user U1, for example, by blocking or reflecting the sound emitted by sound source object A1 before that sound reaches user U1. In addition to stationary objects, obstacle B1 can include living things, such as people, or moving objects, such as machines. If a plurality of sound source objects A1 are present in the three-dimensional sound field, for any given sound source object A1, another sound source object A1 may act as obstacle B1. Sound source objects which do not produce sounds, such as building materials or inanimate objects, as well as sound source objects that emit sound, can both be obstacles B1.

The metadata includes information expressing the shape of the three-dimensional sound field (the space), the shape and position of obstacle B1 present in the three-dimensional sound field, the shape and position of sound source object A1 present in the three-dimensional sound field, and the position and orientation, respectively, of user U1 in the three-dimensional sound field.

The three-dimensional sound field may be either a closed space or an open space, but will be described here as a closed space. The metadata also includes information representing the reflectance of structures that can reflect sound in the three-dimensional sound field, such as floors, walls, or ceilings, and the reflectance of obstacle B1 present in the three-dimensional sound field. Here, the “reflectance” is a ratio of the energies of the reflected sound and incident sound, and is set for each frequency band of the sound. Of course, the reflectance may be set uniformly regardless of the frequency band of the sound. Additionally, if the three-dimensional sound field is an open space, parameters set uniformly for the attenuation rate, diffracted sound, or initial reflected sound, for example, may be used.

Although the foregoing describes reflectance as a parameter related to obstacle B1 or sound source object A1 included in the metadata, information other than the reflectance may be included. For example, information related to the materials of objects may be included as the metadata pertaining to both the sound source object and sound source object that do not emit sounds. Specifically, the metadata may include parameters such as diffusivity, transmittance, sound absorption, or the like.

The volume, emission characteristics (directionality), reproduction conditions, the number and type of sound sources emitting sound from a single object, information specifying a sound source region in an object, and the like may be included as the information related to the sound source object. The reproduction conditions may determine, for example, whether the sound is continuously being emitted or is triggered by an event. The sound source region in the object may be determined according to a relative relationship between the position of user U1 and the position of the object, or may be determined using the object as a reference. When determined according to a relative relationship between the position of user U1 and the position of the object, user U1 can be caused to perceive sound A as being emitted from the right side of the object as seen from user U1, and sound B from the left side, based on a plane in which user U1 is viewing the object. When using the object as a reference, which sound is emitted from which region of the object can be fixed regardless of the direction in which user U1 is looking. For example, user U1 can be caused to perceive a high sound as coming from the right side of the object, and a low sound as coming from the left side of the object, when viewing the object from the front. In this case, if user U1 moves around to the rear of the object, user U1 can be caused to perceive the low sound as coming from the right side of the object, and the high sound as coming from the left side of the object, when viewing the object from the rear.

A time until the initial reflected sound, a reverberation time, a ratio of direct sound to diffused sound, or the like can be included as the metadata related to the space. If the ratio of direct sound to diffused sound is zero, user U1 can be caused to perceive only the direct sound.

Incidentally, although information indicating the position and orientation of user U1 has been described as being included in the bitstream as metadata, information indicating the position and orientation of user U1 that changes interactively need not be included in the bitstream. In this case, information indicating the position and orientation of user U1 is obtained from information other than the bitstream. For example, position information of user U1 in a VR space may be obtained from an app that provides VR content, or the position information of user U1 for presenting sound as AR may be obtained using position information obtained by, for example, a mobile terminal estimating its own position using GPS, cameras, Laser Imaging Detection and Ranging (LIDAR), or the like.

In the embodiment, the metadata includes flag information indicating whether to perform the sound image localization enhancement processing, priority information indicating a priority level of the sound image localization enhancement processing with respect to the acoustic processing, and the like. Note that this information need not be included in the metadata.

Sensor 3 is a device for detecting the position or movement of the head of user U1. Sensor 3 is constituted by, for example, a gyro sensor, or a combination of one or more of various sensors used to detect movement, such as an accelerometer. In the embodiment, sensor 3 is built into acoustic reproduction device 100, but may, for example, be built into an external device, such as a stereoscopic video reproduction device that operates in accordance with the movement of the head of user U1 in the same manner as acoustic reproduction device 100. In this case, sensor 3 need not be included in acoustic reproduction device 100. Alternatively, as sensor 3, the movement of user U1 may be detected by capturing the movement of the head of user U1 using an external image capturing device or the like and processing the captured image.

Sensor 3 is, for example, fixed to a housing of acoustic reproduction device 100 as a part thereof, and senses the speed of movement of the housing. When worn on the head of user U1, acoustic reproduction device 100, which includes the stated housing, moves with the head of user U1, and thus sensor 3 can detect the speed of movement of the head of user U1 as a result.

Sensor 3 may, for example, detect an amount of rotation in at least one of three rotational axes orthogonal to each other in the virtual space as the amount of movement of the head of user U1, or may detect an amount of displacement in at least one of the three axes as a displacement direction. Additionally, sensor 3 may detect both the amount of rotation and the amount of displacement as the amount of movement of the head of user U1.

Driver 4 includes, for example, a vibrating plate, and a driving mechanism such as a magnet, a voice coil, or the like. Driver 4 causes the driving mechanism to operate in accordance with output sound signal Sig3 output from outputter 15, and the driving mechanism causes the vibrating plate to vibrate. In this manner, driver 4 generates a sound wave using the vibration of the vibrating plate based on output sound signal Sig3, the sound wave propagates through the air or the like and reaches the ear of user U1, and user U1 perceives the sound.

Processing module 1 (acoustic processing system 10) will be described in detail hereinafter with reference to FIG. 2.

Obtainer 11 obtains the sound information and the metadata. In the embodiment, the metadata is obtained by extractor 12 in obtainer 11. Upon obtaining the encoded sound information, obtainer 11 decodes the obtained sound information and provides the decoded sound information to sound image localization enhancement processor 13 and acoustic processor 14.

Note that the sound information and metadata may be held in a single bitstream, or may be held separately in a plurality of bitstreams. Likewise, the sound information and metadata may be held in a single file, or may be held separately in a plurality of files.

If the plurality of bitstreams or the plurality of files are held separately, information indicating other bitstreams or files associated with one or more of the bitstreams or files may be included, or information indicating other bitstreams or files associated with all of the bitstreams or files may be included.

Here, the associated bitstreams or files are, for example, bitstreams or files that may be used simultaneously during acoustic processing, for example. A bitstream or file in which information indicating the other associated bitstreams or files is collectively written may be included.

Here, the information indicating the other associated bitstreams or files is, for example, an identifier indicating the other bitstream, a filename indicating the other file, a Uniform Resource Locator (URL), a Uniform Resource Identifier (URI), or the like. In this case, obtainer 11 specifies or obtains the bitstream or file based on the information indicating the other associated bitstreams or files.

Information indicating the other associated bitstreams in the bitstream may be included, as well as information indicating the bitstreams or files associated with the other bitstreams or files. Here, the file containing information indicating the associated bitstream or file may be, for example, a control file such as a manifest file used for delivering content.

Extractor 12 decodes the encoded metadata and provides the decoded metadata to both sound image localization enhancement processor 13 and acoustic processor 14. Here, extractor 12 does not provide the same metadata to both sound image localization enhancement processor 13 and acoustic processor 14, but instead provides the metadata required by the corresponding processor to that processor.

In the embodiment, extractor 12 further obtains detection information including the amount of rotation, the amount of displacement, or the like detected by sensor 3. Extractor 12 determines the position and orientation of user U1 in the three-dimensional sound field (the space) based on the obtained detection information. Then, extractor 12 updates the metadata according to the determined position and orientation of user U1. Accordingly, the metadata provided by extractor 12 to each function unit is the updated metadata.

Based on the sound information and the metadata, sound image localization enhancement processor 13 performs sound image localization enhancement processing of generating first sound signal Sig1 expressing a sound including sound image localization enhancement reflected sound Sd2 (see FIG. 6 and the like) for localization as a sound arriving from a predetermined direction. In the embodiment, sound image localization enhancement processor 13 performs first processing, second processing, and composition processing. In the first processing, a first signal is generated by convolving, with the sound information, a first head-related transfer function for localizing a sound included in the sound information as a sound arriving from a predetermined direction. In the second processing, a second signal is generated by convolving, with the sound information, a second head-related transfer function for localizing a sound included in the sound information as a sound that (i) arrives from a direction different from the predetermined direction and that (ii) has a delay time greater than zero and a volume attenuation greater than zero with respect to the predetermined sound perceived as a result of the first signal. In the composition processing, the first signal and second signal generated are composited, and the resulting composite signal is output as first sound signal Sig1. Note that the sound image localization enhancement processing may be any processing capable of generating sound image localization enhancement reflected sound Sd2, and is not limited to the above-described first processing, second processing, and composition processing.

Based on the sound information and the metadata, acoustic processor 14 performs processing of generating second sound signal Sig2 expressing a sound including a sound other than direct sound Sd1 (see FIG. 6 and the like) that reaches user U1 directly from sound source object A1. In the embodiment, acoustic processor 14 includes initial reflected sound generation processor 141, later reverberation sound generation processor 142, and diffracted sound generation processor 143.

Initial reflected sound generation processor 141 performs initial reflected sound generation processing of generating second sound signal Sig2 indicating a sound including initial reflected sound Sd3 (see FIG. 6 and the like) that reaches user U1 after direct sound Sd1. In other words, the acoustic processing includes the initial reflected sound generation processing. As described earlier, initial reflected sound Sd3 is a reflected sound that reaches user U1 after at least one reflection at a relatively early stage after direct sound Sd1 from sound source object A1 reaches user U1 (e.g., several tens of ms after the time at which direct sound Sd1 arrives).

For example, referring to the sound information and the metadata, initial reflected sound generation processor 141 calculates a path of a reflected sound from sound source object A1, reflected by an object, and reaching user U1, using the shape and size of the three-dimensional sound field (the space), the positions of objects such as structures, the reflectances of the objects, and the like, and generates initial reflected sound Sd3 based on the path.

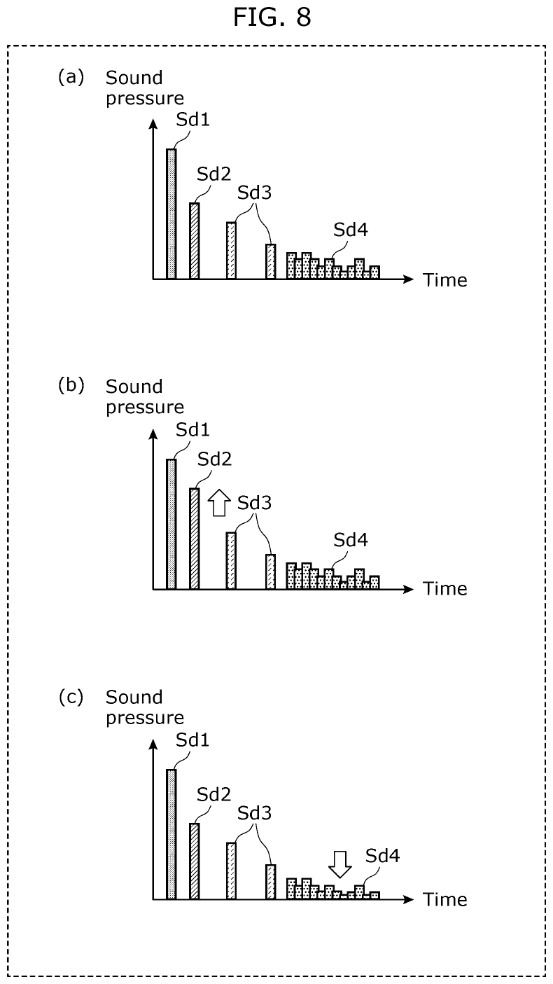

Later reverberation sound generation processor 142 performs later reverberation sound generation processing of generating second sound signal Sig2 indicating a sound including later reverberation sound Sd4 (see FIG. 8 and the like) that reaches user U1 as a reverberation after direct sound Sd1. In other words, the acoustic processing includes the later reverberation sound generation processing. As described earlier, later reverberation sound Sd4 is a reverberation sound that reaches user U1 at a relatively late stage after initial reflected sound Sd3 reaches the user (e.g., between about 100 and 200 ms after the time at which direct sound Sd1), and reaches user U1 after more reflections (e.g., several tens) than the number of reflections of initial reflected sound Sd3.

Later reverberation sound generation processor 142 generates later reverberation sound Sd4 by, for example, performing calculations using a predetermined function for generating later reverberation sound Sd4, prepared in advance, with reference to the sound information and the metadata.

Diffracted sound generation processor 143 performs diffracted sound generation processing of generating second sound signal Sig2 indicating a sound including diffracted sound Sd5 (see FIG. 10) caused by obstacle B1 located between user U1 and sound source object A1 in the three-dimensional sound field (the space). In other words, the acoustic processing includes the diffracted sound generation processing. As described earlier, diffracted sound Sd5 is a sound that, when obstacle B1 is present between sound source object A1 and user U1, reaches user U1 from sound source object A1 having traveled around obstacle B1.

For example, referring to the sound information and metadata, diffracted sound generation processor 143 calculates a path from sound source object A1, around obstacle B1, and reaching user U1 using the position of sound source object A1 in the three-dimensional sound field (the space), the position of user U1, the position, shape, and size of obstacle B1, and the like, and generates diffracted sound Sd5 based on the path.

Outputter 15 outputs output sound signal Sig3, obtained by compositing first sound signal Sig1 and second sound signal Sig2, to driver 4.

### 3. Operations

Operations by acoustic processing system 10 according to the embodiment, i.e., an acoustic processing method, will be described hereinafter.

### 3-1. Basic Operations

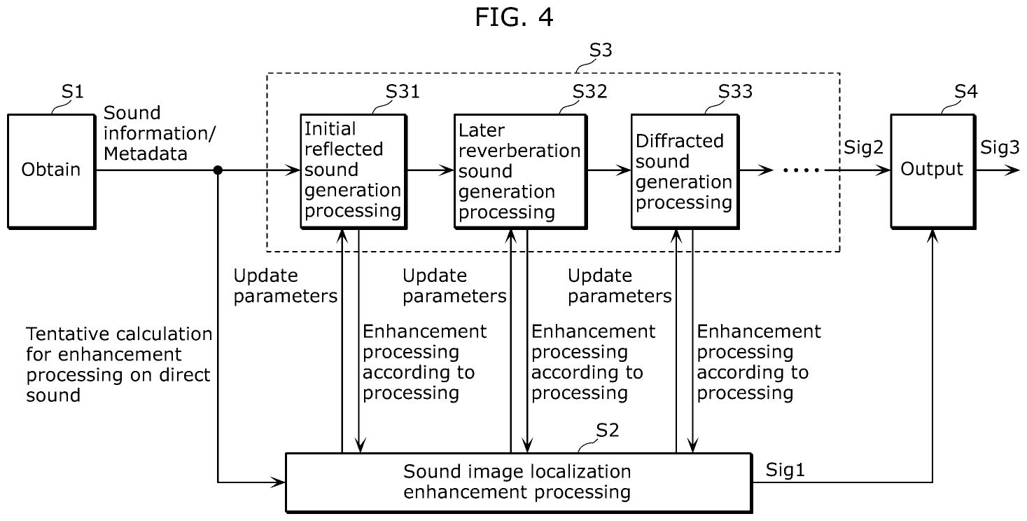

Basic operations performed by acoustic processing system 10 according to the embodiment will be described first with reference to FIG. 4. FIG. 4 is an explanatory diagram illustrating an example of basic operations performed in acoustic processing system 10 according to the embodiment. The example illustrated in FIG. 4 assumes that the sound image localization enhancement processing is performed. The example illustrated in FIG. 4 also assumes that each of the sound image localization enhancement processing and the acoustic processing refers to the parameters of the other.

First, when the operations of acoustic reproduction device 100 are started, obtainer 11 obtains the sound information and the metadata through communication module 2 (S1). Next, sound image localization enhancement processor 13 starts the sound image localization enhancement processing based on the obtained sound information and the metadata (S2). At this point, sound image localization enhancement processor 13 tentatively calculates sound image localization enhancement reflected sound Sd2 by performing the sound image localization enhancement processing on direct sound Sd1 from sound source object A1 to user U1.

Additionally, acoustic processor 14 starts the acoustic processing based on the obtained sound information and the metadata (S3). In the embodiment, in the acoustic processing, initial reflected sound generation processing by initial reflected sound generation processor 141 (S31), later reverberation sound generation processing by later reverberation sound generation processor 142 (S32), and diffracted sound generation processing by diffracted sound generation processor 143 (S33) are performed in that order. The sound image localization enhancement processing is also performed in parallel during the acoustic processing.

Here, in the sound image localization enhancement processing, enhancement processing can be performed, i.e., the parameters of sound image localization enhancement reflected sound Sd2 can be updated, in accordance with the initial reflected sound generation processing. Additionally, in the initial reflected sound generation processing, the parameters of initial reflected sound Sd3 can be updated in accordance with the sound image localization enhancement processing. The parameters referred to here include the timing at which the sound is generated, the sound pressure, the frequency, and the like.

Additionally, in the sound image localization enhancement processing, enhancement processing can be performed, i.e., the parameters of sound image localization enhancement reflected sound Sd2 can be updated, in accordance with the later reverberation sound generation processing. Additionally, in the later reverberation sound generation processing, the parameters of later reverberation sound Sd4 can be updated in accordance with the sound image localization enhancement processing. Additionally, in the sound image localization enhancement processing, enhancement processing can be performed, i.e., the parameters of sound image localization enhancement reflected sound Sd2 can be updated, in accordance with the diffracted sound generation processing. Additionally, in the diffracted sound generation processing, the parameters of diffracted sound Sd5 can be updated in accordance with the sound image localization enhancement processing.

As described above, with acoustic processing system 10 (the acoustic processing method) according to the embodiment, at least one of the sound image localization enhancement processing or the acoustic processing refers to a parameter used in an other of the sound image localization enhancement processing or the acoustic processing. Although each of the sound image localization enhancement processing and the acoustic processing refers to the parameters of the other in the example illustrated in FIG. 4, only one instance of processing may refer to the parameters used in the other instance of processing.

Then, outputter 15 composites first sound signal Sig1 generated by sound image localization enhancement processor 13 and second sound signal Sig2 generated by acoustic processing, and outputs the composited output sound signal Sig3 (S4). Here, first sound signal Sig1 includes sound image localization enhancement reflected sound Sd2 generated according to the parameters updated in accordance with each of the initial reflected sound generation processing, the later reverberation sound generation processing, and the diffracted sound generation processing. Additionally, second sound signal Sig2 includes initial reflected sound Sd3, later reverberation sound Sd4, and diffracted sound Sd5, respectively, generated in accordance with the parameters updated in accordance with the sound image localization enhancement processing. Note that there are situations where, depending on the processing, the parameters are not updated.

### 3-2. Reciprocal Processing Between Initial Reflected Sound Generation Processing and Sound Image Localization Enhancement Processing

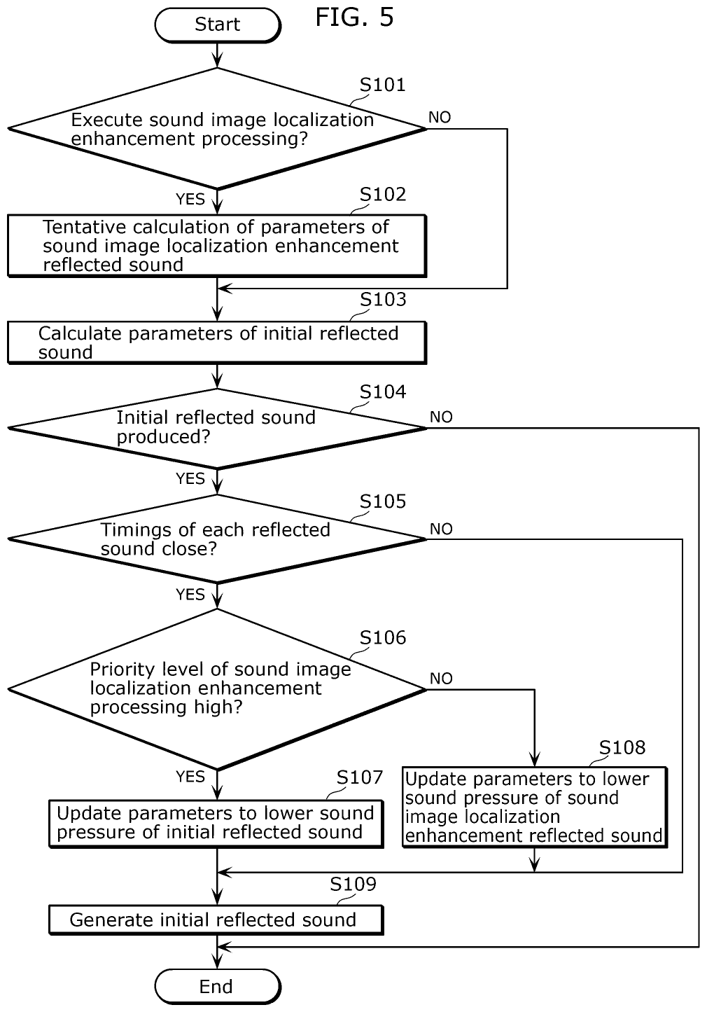

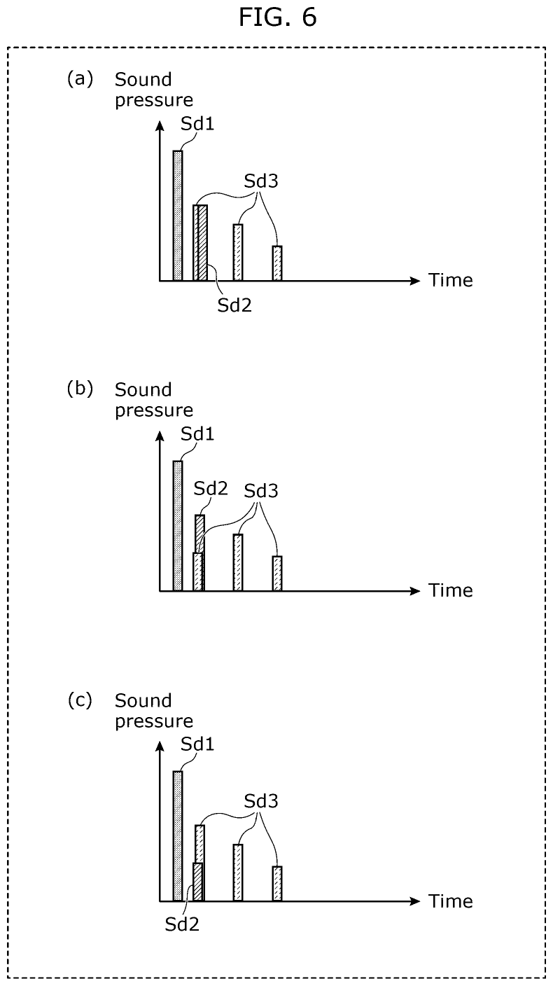

An example of reciprocal processing between the initial reflected sound generation processing and the sound image localization enhancement processing will be described next with reference to FIG. 5. FIG. 5 is a flowchart illustrating an example of reciprocal processing performed between sound image localization enhancement processing and initial reflected sound generation processing according to the embodiment.

First, if the metadata includes flag information indicating that the sound image localization enhancement processing is to be performed (S101: Yes), sound image localization enhancement processor 13 tentatively calculates the parameters of sound image localization enhancement reflected sound Sd2 (S102). Next, initial reflected sound generation processor 141 calculates the parameters of initial reflected sound Sd3 (S103). Note that if the metadata includes flag information indicating that the sound image localization enhancement processing is not to be performed (S101: No), the sound image localization enhancement processing is not performed, and initial reflected sound generation processor 141 calculates the parameters of initial reflected sound Sd3 (S103). Unless noted otherwise, the following assumes that the sound image localization enhancement processing is performed.

Next, if initial reflected sound Sd3 is generated (S104: Yes) and the timings at which sound image localization enhancement reflected sound Sd2 and initial reflected sound Sd3 are generated are close (S105: Yes), processing module 1 refers to priority information included in the metadata. Here, the timings at which sound image localization enhancement reflected sound Sd2 and initial reflected sound Sd3 are generated being close corresponds to a case where a difference between the timing at which sound image localization enhancement reflected sound Sd2 is generated and the timing at which initial reflected sound Sd3 is generated is not greater than a threshold. The threshold can be set as appropriate in advance.

Then, if the priority level of the sound image localization enhancement processing is higher (S106: Yes), initial reflected sound generation processor 141 updates the parameters of initial reflected sound Sd3 such that the sound pressure of initial reflected sound Sd3 is lower than sound image localization enhancement reflected sound Sd2 (S107). On the other hand, if the priority level of the sound image localization enhancement processing is lower (S106: No), sound image localization enhancement processor 13 updates the parameters of sound image localization enhancement reflected sound Sd2 such that the sound pressure of sound image localization enhancement reflected sound Sd2 is lower than initial reflected sound Sd3 (S108).

Initial reflected sound generation processor 141 then generates initial reflected sound Sd3 according to the updated parameters (S109). Initial reflected sound Sd3 generated in this manner is included in second sound signal Sig2.

Note that if the timings at which sound image localization enhancement reflected sound Sd2 and initial reflected sound Sd3 are generated are far from each other (S105: No), neither the parameters of sound image localization enhancement reflected sound Sd2 nor the parameters of initial reflected sound Sd3 are updated, and initial reflected sound generation processor 141 generates initial reflected sound Sd3 according to the parameters that have not been updated (S109). In addition, if initial reflected sound Sd3 is not generated (S104: No), the processing ends without generating initial reflected sound Sd3.

FIG. 6 is an explanatory diagram illustrating a relationship between sound image localization enhancement reflected sound Sd2 and initial reflected sound Sd3 according to the embodiment. In FIG. 6, the vertical axis represents sound pressure, and the horizontal axis represents time. (a) in FIG. 6 represents a case of a determination of “Yes” in step S105 of FIG. 5, i.e., a case where the timings at which sound image localization enhancement reflected sound Sd2 and initial reflected sound Sd3 are generated are close. Specifically, in the example illustrated in (a) of FIG. 6, three initial reflected sounds Sd3 are generated, and the timing at which the first initial reflected sound Sd3 is generated is close to the timing at which sound image localization enhancement reflected sound Sd2 is generated.

(b) in FIG. 6 represents a case where the priority level of sound image localization enhancement processing is higher. In other words, in the example illustrated in (b) of FIG. 6, the sound pressure of the first initial reflected sound Sd3 is lowered to about half the sound pressure of sound image localization enhancement reflected sound Sd2. (c) in FIG. 6 represents a case where the priority level of sound image localization enhancement processing is lower. In other words, in the example illustrated in (c) of FIG. 6, the sound pressure of sound image localization enhancement reflected sound Sd2 is lowered to about half the sound pressure of the first initial reflected sound Sd3.

As described above, in acoustic processing system 10 (acoustic processing method) according to the embodiment, the parameter (here, the sound pressure) of at least one of sound image localization enhancement reflected sound Sd2 or initial reflected sound Sd3 is adjusted based on the timing at which sound image localization enhancement reflected sound Sd2 is generated and the timing at which initial reflected sound Sd3 is generated. As a result, it is unlikely that sound image localization enhancement reflected sound Sd2 and initial reflected sound Sd3 will interfere with each other.

Note that the amount by which the sound pressure is lowered may be set in advance. Alternatively, if information indicating the amount by which the sound pressure is lowered is included in the metadata, the amount by which the sound pressure is lowered may be determined by referring to the metadata. Additionally, although the sound pressure of either sound image localization enhancement reflected sound Sd2 or initial reflected sound Sd3 is lowered in the example illustrated in FIGS. 5 and 6, the sound pressure of one of those sounds may be raised instead.

### 3-3. Reciprocal Processing Between Later Reverberation Sound Generation Processing and Sound Image Localization Enhancement Processing

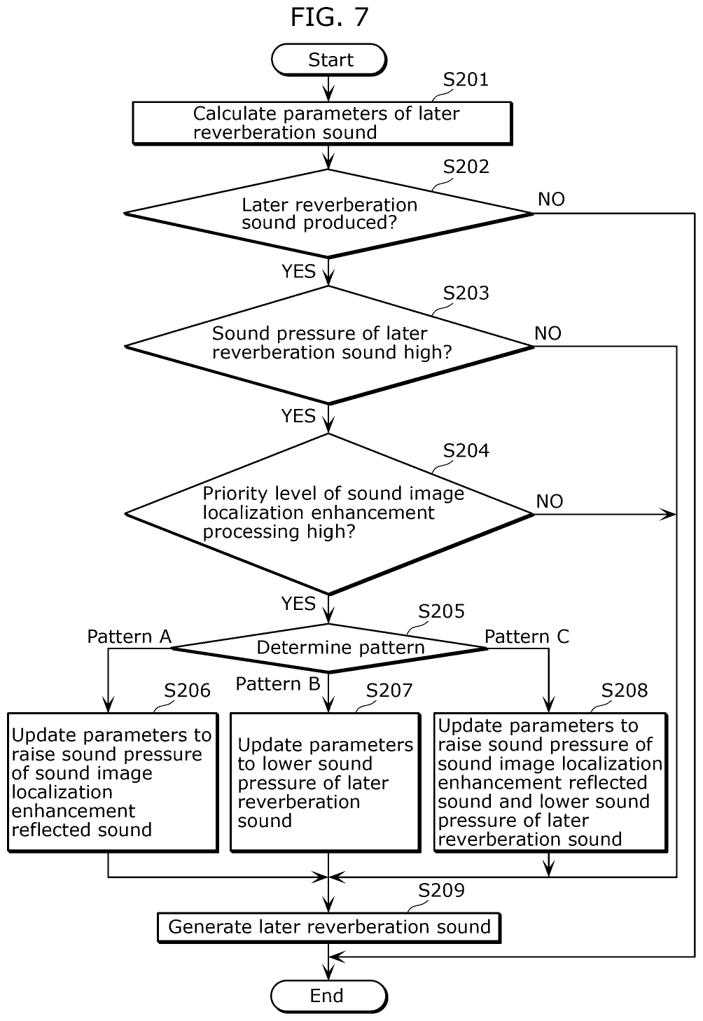

An example of reciprocal processing between the later reverberation sound generation processing and the sound image localization enhancement processing will be described next with reference to FIG. 7. FIG. 7 is a flowchart illustrating an example of reciprocal processing performed between sound image localization enhancement processing and later reverberation sound generation processing according to the embodiment.

First, later reverberation sound generation processor 142 calculates the parameters of later reverberation sound Sd4 (S201). Next, if later reverberation sound Sd4 is generated (S202: Yes) and the sound pressure of later reverberation sound Sd4 is greater than a predetermined value (S203: Yes), processing module 1 refers to the priority information included in the metadata. The predetermined value can be set as appropriate in advance.

Then, if the priority level of the sound image localization enhancement processing is higher (S204: Yes), later reverberation sound generation processor 142 determines which of three patterns (pattern A, pattern B, and pattern C) applies by referring to the metadata (S205).

If the pattern is pattern A, sound image localization enhancement processor 13 updates the parameters of sound image localization enhancement reflected sound Sd2 to raise the sound pressure of sound image localization enhancement reflected sound Sd2 (S206). If the pattern is pattern B, later reverberation sound generation processor 142 updates the parameters of later reverberation sound Sd4 to lower the sound pressure of later reverberation sound Sd4 (S207). If the pattern is pattern C, sound image localization enhancement processor 13 updates the parameters of sound image localization enhancement reflected sound Sd2 to raise the sound pressure of sound image localization enhancement reflected sound Sd2, and later reverberation sound generation processor 142 updates the parameters of later reverberation sound Sd4 to lower the sound pressure of later reverberation sound Sd4 (S208).

Later reverberation sound generation processor 142 then generates later reverberation sound Sd4 according to the updated parameters (S209). Later reverberation sound Sd4 generated in this manner is included in second sound signal Sig2.

Note that if the sound pressure of later reverberation sound Sd4 is lower than a predetermined value (S203: No), or if the priority level of sound image localization enhancement processing is lower (S204: No), neither the parameters of sound image localization enhancement reflected sound Sd2 nor the parameters of later reverberation sound Sd4 are updated, and later reverberation sound generation processor 142 generates later reverberation sound Sd4 according to the parameters that have not been updated (S209). In addition, if later reverberation sound Sd4 is not generated (S202: No), the processing ends without generating later reverberation sound Sd4.

FIG. 8 is an explanatory diagram illustrating a relationship between sound image localization enhancement reflected sound Sd2 and later reverberation sound Sd4 according to the embodiment. In FIG. 8, the vertical axis represents sound pressure, and the horizontal axis represents time. (a) in FIG. 8 represents a case of a determination of “Yes” in step S204 of FIG. 7, i.e., a case where the sound pressure of later reverberation sound Sd4 is greater than the predetermined value and the priority level of sound image localization enhancement processing is higher.

(b) in FIG. 8 represents pattern A. In other words, in the example illustrated in (b) of FIG. 8, the sound pressure of sound image localization enhancement reflected sound Sd2 is raised. (c) in FIG. 8 represents pattern B. In other words, in the example illustrated in (c) of FIG. 8, the sound pressure of later reverberation sound Sd4 is lowered.

As described above, in acoustic processing system 10 (the acoustic processing method) according to the embodiment, the parameters of at least one of sound image localization enhancement reflected sound Sd2 or later reverberation sound Sd4 are adjusted based on the sound pressure of later reverberation sound Sd4. As a result, sound image localization enhancement reflected sound Sd2 is easier to enhance with respect to later reverberation sound Sd4.

Note that the amount by which the sound pressure is lowered or raised may be set in advance. Alternatively, if information indicating the amount by which the sound pressure is lowered or raised is included in the metadata, the amount by which the sound pressure is lowered or raised may be determined by referring to the metadata.

### 3-4. Reciprocal Processing Between Diffracted Sound Generation Processing and Sound Image Localization Enhancement Processing

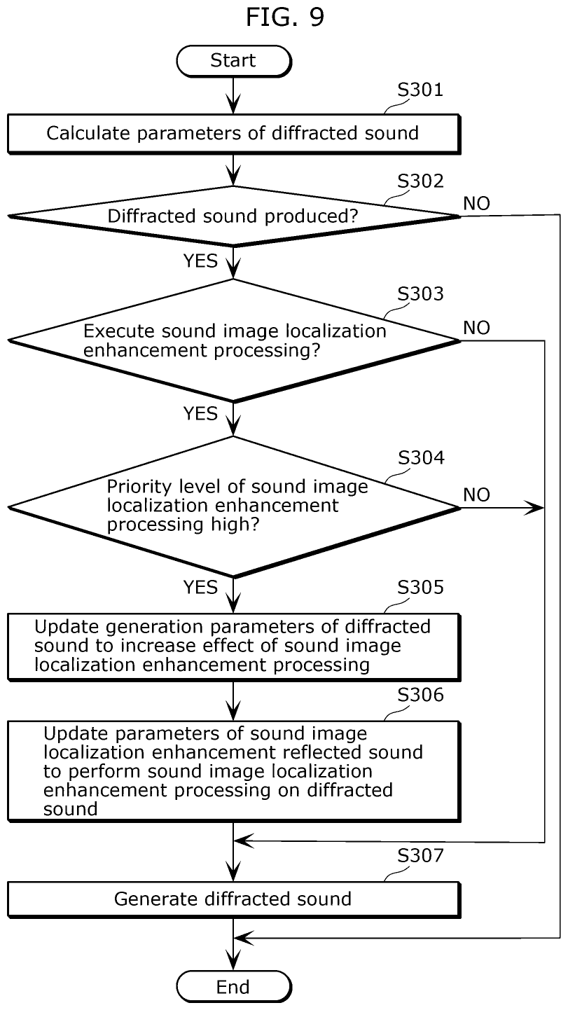

An example of reciprocal processing between the diffracted sound generation processing and the sound image localization enhancement processing will be described next with reference to FIG. 9. FIG. 9 is a flowchart illustrating an example of reciprocal processing performed between sound image localization enhancement processing and diffracted sound generation processing according to the embodiment.

First, diffracted sound generation processor 143 calculates the parameters of diffracted sound Sd5 (S301). Next, if diffracted sound Sd5 is generated (S302: Yes) and the sound image localization enhancement processing is performed (S303: Yes), processing module 1 refers to the priority information included in the metadata.

Then, if the priority level of the sound image localization enhancement processing is higher (S304: Yes), diffracted sound generation processor 143 updates the parameters of diffracted sound Sd5 such that the sound image localization enhancement processing has a greater effect (S305). For example, diffracted sound generation processor 143 updates the parameters of diffracted sound Sd5 to raise a frequency component in a predetermined frequency band (e.g., a frequency band of at least 1 kHz) of diffracted sound Sd5. Additionally, sound image localization enhancement processor 13 updates the parameters of sound image localization enhancement reflected sound Sd2 to perform the sound image localization enhancement processing on diffracted sound Sd5 (S306). In other words, if diffracted sound Sd5 is generated, diffracted sound Sd5 is generated instead of direct sound Sd1, and thus the sound image localization enhancement processing is performed on diffracted sound Sd5 instead of performing the sound image localization enhancement processing on direct sound Sd1.

Diffracted sound generation processor 143 then generates diffracted sound Sd5 according to the updated parameters (S307). Diffracted sound Sd5 generated in this manner is included in second sound signal Sig2.

Note that if the sound image localization enhancement processing is not performed (S303: No), or if the priority level of the sound image localization enhancement processing is lower (S304: No), neither the parameters of sound image localization enhancement reflected sound Sd2 nor the parameters of diffracted sound Sd5 are updated, and diffracted sound generation processor 143 generates diffracted sound Sd5 according to the parameters that have not been updated (S307). In addition, if diffracted sound Sd5 is not generated (S302: No), the processing ends without generating diffracted sound Sd5.

FIG. 10 is an explanatory diagram illustrating a relationship between sound image localization enhancement reflected sound Sd2 and diffracted sound Sd5 according to the embodiment. (a) in FIG. 10 illustrates a situation where there is no obstacle B1 between sound source object A1 and user U1 in the three-dimensional sound field (the space) and direct sound Sd1 reaches user U1 from sound source object A1. (b) in FIG. 10 represents direct sound Sd1, sound image localization enhancement reflected sound Sd2, initial reflected sound Sd3, and later reverberation sound Sd4 in the situation illustrated in (a) of FIG. 10. On the other hand, (c) in FIG. 10 illustrates a situation where obstacle B1 is present between sound source object A1 and user U1 in the three-dimensional sound field, and diffracted sound Sd5 reaches user U1 from sound source object A1 having traveled around obstacle B1. (d) in FIG. 10 represents diffracted sound Sd5, sound image localization enhancement reflected sound Sd2, initial reflected sound Sd3, and later reverberation sound Sd4 in the situation illustrated in (c) of FIG. 10. In (a) and (c) of FIG. 10, the vertical axis represents sound pressure, and the horizontal axis represents time. In addition, in (d) of FIG. 10, the solid black blocks represent direct sound Sd1 that is eliminated, and the blocks with solid line hatching represent the timing at which sound image localization enhancement reflected sound Sd2 is generated in (b) of FIG. 10.

As illustrated in (d) of FIG. 10, if diffracted sound Sd5 is generated, direct sound Sd1 is eliminated. Additionally, sound image localization enhancement reflected sound Sd2 is generated at a timing based on diffracted sound Sd5, rather than at a timing based on direct sound Sd1. Sound image localization enhancement reflected sound Sd2 has a magnitude based diffracted sound Sd5, rather than a magnitude based on the sound pressure of direct sound Sd1.

As described above, in acoustic processing system 10 (the acoustic processing method) according to the embodiment, the parameters of at least one of sound image localization enhancement reflected sound Sd2 or diffracted sound Sd5 are adjusted. As a result, sound image localization enhancement reflected sound Sd2 is easier to enhance with respect to diffracted sound Sd5.

Note that the amount by which the frequency component of the predetermined frequency band is raised or lowered may be set in advance. Alternatively, if information indicating the amount by which the frequency component of the predetermined frequency band is raised or lowered is included in the metadata, the amount by which the frequency component of the predetermined frequency band is raised or lowered may be determined by referring to the metadata.

### 4. Advantages

Advantages of acoustic processing system 10 (the acoustic processing method) according to the embodiment will be described hereinafter with comparison to an acoustic processing system of a comparative example. The acoustic processing system of the comparative example differs from acoustic processing system 10 according to the embodiment in that the sound image localization enhancement processing and the acoustic processing are performed independently.

When the acoustic processing system of the comparative example is used, the sound image localization enhancement processing generates sound image localization enhancement reflected sound Sd2 without referring to the parameters used in the acoustic processing. Likewise, in the acoustic processing, sound such as initial reflected sound Sd3 is generated without referring to the parameters used in the sound image localization enhancement processing. Accordingly, when the acoustic processing system of the comparative example is used, there is a problem in that (i) sound image localization enhancement reflected sound Sd2 and the sound generated in the acoustic processing interfere with each other and strengthen or weaken each other, resulting in an insufficient sound image localization enhancement effect, and that (ii) it is difficult to achieve the desired stereoscopic acoustics.

In contrast, in acoustic processing system 10 (the acoustic processing method) according to the embodiment, the sound generated by at least one of the sound image localization enhancement processing and the acoustic processing is adjusted in accordance with the sound generated by the other instance of processing. Accordingly, when acoustic processing system 10 according to the embodiment is used, sound image localization enhancement reflected sound Sd2 and sound generated by acoustic processing are less likely to interfere with each other and strengthen or weaken each other than when using the acoustic processing system of the comparative example.

Accordingly, when acoustic processing system 10 (the acoustic processing method) according to the embodiment is used, it is easier to achieve a sufficient sound image localization enhancement effect, and easier to realize the desired stereoscopic acoustics, than when using the acoustic processing system of the comparative example. In other words, acoustic processing system 10 (the acoustic processing method) according to the embodiment has an advantage in that it is easy for user U1 to perceive a stereoscopic sound more appropriately.

### OTHER EMBODIMENTS

Although an embodiment has been described thus far, the present disclosure is not limited to the foregoing embodiment.

For example, in the above embodiment, in the sound image localization enhancement processing performed by sound image localization enhancement processor 13, first sound signal Sig1 may be generated based on the position of user U1 and the position of sound source object A1 in the three-dimensional sound field (the space).

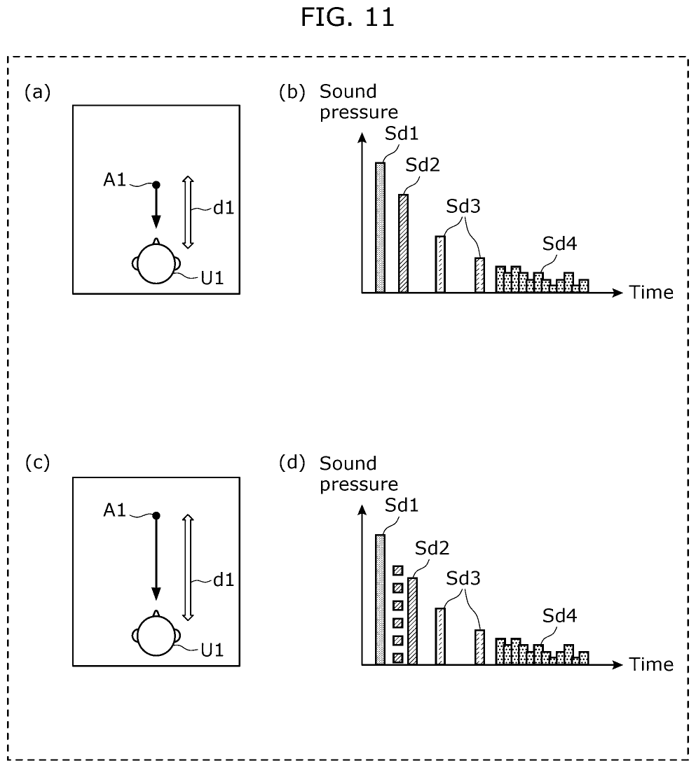

FIG. 11 is an explanatory diagram illustrating operations performed by sound image localization enhancement processor 13 according to a variation on the embodiment. (a) in FIG. 11 represents a situation where distance d1 between sound source object A1 and user U1 in the three-dimensional sound field (the space) is relatively short. (b) in FIG. 11 represents direct sound Sd1, sound image localization enhancement reflected sound Sd2, initial reflected sound Sd3, and later reverberation sound Sd4 in the situation illustrated in (a) of FIG. 11. Meanwhile, (c) in FIG. 11 represents a situation where distance d1 between sound source object A1 and user U1 in the three-dimensional sound field is relatively long. (d) in FIG. 11 represents direct sound Sd1, sound image localization enhancement reflected sound Sd2, initial reflected sound Sd3, and later reverberation sound Sd4 in the situation illustrated in (c) of FIG. 11.

In (b) and (d) of FIG. 11, the vertical axis represents sound pressure, and the horizontal axis represents time. In addition, in (d) of FIG. 11, the blocks with solid line hatching represent the timing at which sound image localization enhancement reflected sound Sd2 is generated in (b) of FIG. 11.

As illustrated in FIG. 11, in the sound image localization enhancement processing performed by sound image localization enhancement processor 13, when distance d1 between user U1 and sound source object A1 increases, and sound image localization enhancement reflected sound Sd2 is generated such that the timing thereof is later and the sound pressure thereof is lower in accordance with distance d1.

Generating an appropriate sound image localization enhancement reflected sound Sd2 in accordance with the positional relationship between user U1 and sound source object A1 in this manner makes it easier for the user to perceive stereoscopic sound more appropriately.

Note that in the above embodiment, the sound image localization enhancement processing performed by sound image localization enhancement processor 13 may be performed based on parameters set in advance, rather than referring to the position of user U1 and the position of sound source object A1.

In the foregoing embodiment, acoustic processor 14 may perform processing other than the initial reflected sound generation processing, the later reverberation sound generation processing, and the diffracted sound generation processing. For example, acoustic processor 14 may perform transmission processing for the sound signal, addition processing that adds an acoustic effect such as a Doppler effect to the sound signal, or the like. Such processing may refer to the parameters used in the sound image localization enhancement processing as well. Likewise, the sound image localization enhancement processing may refer to the parameters used in such processing.

In the foregoing embodiment, obtainer 11 obtains the sound information and metadata from an encoded bitstream, but the configuration is not limited thereto. For example, obtainer 11 may obtain the sound information and the metadata separately from information other than a bitstream.

Additionally, for example, the acoustic reproduction device described in the foregoing embodiment may be implemented as a single device having all of the constituent elements, or may be implemented by assigning the respective functions to a plurality of corresponding devices and having the plurality of devices operate in tandem. In the latter case, information processing devices such as smartphones, tablet terminals, PCs, or the like may be used as the devices corresponding to the processing modules.

The acoustic reproduction device of the present disclosure can be realized as an acoustic processing device that is connected to a reproduction device provided only with a driver and that only outputs a sound signal to the reproduction device. In this case, the acoustic processing device may be implemented as hardware having dedicated circuitry, or as software for causing a general-purpose processor to execute specific processing.

Additionally, processing executed by a specific processing unit in the foregoing embodiment may be executed by a different processing unit. Additionally, the order of multiple processes may be changed, and multiple processes may be executed in parallel.

Additionally, in the foregoing embodiment, the constituent elements may be implemented by executing software programs corresponding to those constituent elements. Each constituent element may be realized by a program executing unit such as a Central Processing Unit (CPU) or a processor reading out and executing a software program recorded into a recording medium such as a hard disk or semiconductor memory.

Each constituent element may be implemented by hardware. For example, each constituent element may be circuitry (or integrated circuitry). This circuitry may constitute a single overall circuit, or may be separate circuits. The circuitry may be generic circuitry, or may be dedicated circuitry.

The general or specific aspects of the present disclosure may be implemented by a device, a method, an integrated circuit, a computer program, or a computer-readable recording medium such as a CD-ROM. The general or specific aspects of the present disclosure may also be implemented by any desired combination of systems, devices, methods, integrated circuits, computer programs, and recording media.

For example, the present disclosure may be realized as an acoustic processing method executed by a computer, or as a program for causing a computer to execute the acoustic processing method. The present disclosure may be implemented as a non-transitory computer-readable recording medium in which such a program is recorded.

Additionally, embodiments achieved by one skilled in the art making various conceivable variations on the embodiment, embodiments achieved by combining constituent elements and functions from the embodiment as desired within a scope which does not depart from the spirit of the present disclosure, and the like are also included in the present disclosure.

### INDUSTRIAL APPLICABILITY

The present disclosure is useful in acoustic reproduction such as for causing a user to perceive stereoscopic sound.

1. An acoustic processing method comprising:
obtaining (i) sound information related to a sound including a predetermined sound and (ii) metadata including information related to a space in which the predetermined sound is reproduced;
performing, based on the sound information and the metadata, sound image localization enhancement processing of generating a first sound signal expressing a sound including a sound image localization enhancement reflected sound for localization as a sound arriving from a predetermined direction;
performing, based on the sound information and the metadata, acoustic processing of generating a second sound signal expressing a sound including a sound other than a direct sound that reaches a user directly from a sound source object; and
outputting an output sound signal obtained by compositing the first sound signal and the second sound signal,
wherein at least one of the sound image localization enhancement processing or the acoustic processing is performed with reference to a parameter used in an other of the sound image localization enhancement processing or the acoustic processing.

2. The acoustic processing method according to claim 1,
wherein the acoustic processing includes initial reflected sound generation processing of generating the second sound signal expressing a sound including an initial reflected sound that reaches the user after the direct sound, and
in the performing of the acoustic processing, a parameter of at least one of the sound image localization enhancement reflected sound or the initial reflected sound is adjusted based on a timing at which the sound image localization enhancement reflected sound is generated and a timing at which the initial reflected sound is generated.

3. The acoustic processing method according to claim 1,
wherein the acoustic processing includes later reverberation sound generation processing of generating the second sound signal expressing a sound including a later reverberation sound that reaches the user after the direct sound as a reverberation, and
in the performing of the acoustic processing, a parameter of at least one of the sound image localization enhancement reflected sound or the later reverberation sound is adjusted based on a sound pressure of the later reverberation sound.

4. The acoustic processing method according to claim 1,
wherein the acoustic processing includes diffracted sound generation processing of generating the second sound signal expressing a sound including a diffracted sound caused by an obstacle located between the user and the sound source object in the space, and
in the performing of the acoustic processing, a parameter of at least one of the sound image localization enhancement reflected sound or the diffracted sound is adjusted.

5. The acoustic processing method according to claim 1,
wherein the metadata includes information indicating which of the sound image localization enhancement processing or the acoustic processing is to be prioritized.

6. The acoustic processing method according to claim 1,
wherein the sound image localization enhancement processing includes generating the first sound signal based on a position of the user and a position of the sound source object in the space.

7. A non-transitory computer-readable recording medium having recorded thereon a program for causing a computer to execute the acoustic processing method according to claim 1.

8. An acoustic processing system comprising:
an obtainer that obtains (i) sound information related to a sound including a predetermined sound and (ii) metadata including information related to a space in which the predetermined sound is reproduced;
a sound image localization enhancement processor that, based on the sound information and the metadata, performs sound image localization enhancement processing of generating a first sound signal expressing a sound including a sound image localization enhancement reflected sound for localization as a sound arriving from a predetermined direction;
an acoustic processor that, based on the sound information and the metadata, performs acoustic processing of generating a second sound signal expressing a sound including a sound other than a direct sound that reaches a user directly from a sound source object; and
an outputter that outputs an output sound signal obtained by compositing the first sound signal and the second sound signal,
wherein at least one of the sound image localization enhancement processing or the acoustic processing is performed with reference to a parameter used in an other of the sound image localization enhancement processing or the acoustic processing.
